(19) United States
(12) Patent Application Publication
(10) Pub. No.: US 2023/0396965 A1
(43) Pub. Date: Dec. 7, 2023

(54) METHODS AND SYSTEMS FOR RRC STATE MAINTENANCE FOR RECEIVING MULTICAST AND BROADCAST SERVICES

(71) Applicant: Samsung Electronics Co., Ltd., Suwon-si, Gyeonggi-du (KR)

(72) Inventors: Vinay Kumar SHRIVASTAVA, Bangalore (IN); Sangkyu BAEK, Suwon-si (KR)

(21) Appl. No.: 18/034,204

(22) PCT Filed: Nov. 5, 2021
(86) PCT No.: PCT/KR2021/015997

§ 371 Date: Apr. 27, 2023

(30) Foreign Application Priority Data
Nov. 5, 2020 (IN) 202041048332
Oct. 8, 2021 (IN) 2020 41048332

(51) Int. Cl. H04W 4/06; H04W 76/27; H04W 76/40

(52) U.S. Cl. CPC H04W 4/06; H04W 76/27; H04W 76/40

(57) ABSTRACT

Methods and systems for RRC state maintenance for receiving multicast and broadcast services. Embodiments detect, by a UE, MBS transmission and/or reception from MAC entities associated with the UE, when the UE is operating in RRC_CONNECTED state. If expiry of a data inactivity timer, which is started on determining the MBS transmission and/or MBS reception, is detected, upper layer in the UE can be informed about the expiry of the data inactivity timer. Thereafter, the UE transitions to RRC_IDLE or RRC_INACTIVE states. A MBS specific data inactivity timer can be configured on determining the MBS transmission and/or MBS reception; and if the MBS specific data inactivity timer expires, the upper layers facilitate transition to the RRC_IDLE or RRC_INACTIVE states. The UE can receive MBS configuration or commands, from a network, to remain in RRC_CONNECTED state, transition to RRC_CONNECTED state, or transition to RRC_IDLE or RRC_INACTIVE states.

### TECHNICAL FIELD

Embodiments herein relate to Radio Resource Control (RRC) state management for multicast and broadcast services delivery in wireless communication networks, and more particularly to methods and systems for managing RRC state of user devices during reception of multicast and broadcast Services.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Currently, wireless communication systems (such as New Radio (NR)) are aiming at providing support for multicast and broadcast services. The mechanisms and processes for enabling the support is (or will be) detailed in the relevant specifications of 3 rd Generation Partnership Project (3GPP). The NR systems can provide support for the multicast services and the broadcast services using Multicast and Broadcast Services (MBS). In legacy wireless communication systems (such as Long Term Evolution (LTE)), support for multicast and broadcast services is enabled through Multimedia Broadcast Multicast Services (MBMS). However, the architecture and the requirements of MBS are likely to differ greatly from that of MBS. Therefore, efforts have been channelized for designing the architecture for a wireless communication network, providing support for multicast and broadcast services, and user devices (such as User Equipment (UE)) connected to the wireless communication network.

The multicast services may refer to services that are transmitted by a wireless communication network, and received by a plurality of UEs registered to a group (such as Mission Critical Push-To-Talk (MCPTT). The broadcast services may refer to services that are being transmitted by the wireless communication network and can be availed by all UEs within a specific coverage area or one or more UEs subscribed to avail the broadcast services. The UEs may not register with specific or generic groups for broadcast services. Therefore, effectively, both multicast and broadcast services can be utilized using MBS Point-To-Multipoint (PTM) bearer as there is one transmitter and multiple recipients of the transmitted contents. It is also possible to provide the multicast and broadcast services using Point-to-Point (PTP) bearers. There can be scenarios, wherein a plurality of PTP bearers can be used for providing the same MBS to multiple recipients. Apart from multicast and broadcast services, there is another category of services termed as unicast, wherein there is a one to one dedicated connection between a transmitter and a receiver.

The approaches adopted by the existing methods for guiding UE behavior, in terms of managing Radio Resource Control (RRC) state of the UE during MBS reception, lead to an increase in power consumption of the UE. The UE behavior is not deterministic as the UE may either continue to operate in RRC_CONNECTED state, consuming higher battery power; or the UE may transit to RRC_IDLE state or RRC_INACTIVE state, in which the UE may not be able to meet a predefined criterion required for ensuring reliability of MBS reception or loose the MBS reception.

### DISCLOSURE OF INVENTION

### Technical Problem

The principal object of the embodiments herein is to disclose methods and systems for managing Radio Resource Control (RRC) state of a User Equipment (UE) during reception of unicast services, multicast services and broadcast services.

Another object of the embodiments herein is to configure a data inactivity timer, wherein the data inactivity timer can track multicast and unicast transmission from, or reception at, one or more Media Access Control (MAC) entities associated with the UE.

Another object of the embodiments herein is to enable the UE to transit from a RRC_CONNECTED state to a RRC_INACTIVE state or RRC_IDLE state on detecting that the data inactivity timer has expired and continue receiving at least one of the multicast services and the broadcast services in the RRC_INACTIVE state or the RRC_IDLE state.

Another object of the embodiments herein is to maintain Point to Multipoint (PTM) configuration for the multicast services and broadcast services while receiving at least one of the multicast services and the broadcast services, in the RRC_INACTIVE state or the RRC_IDLE state.

Another object of the embodiments herein is to either maintain the PTM configuration, and discard or store a Point to Point (PTP) configuration; or switch from a PTP bearer to a PTM bearer; while receiving at least one of the multicast services and the broadcast services, in the RRC_INACTIVE state or the RRC_IDLE state.

Another object of the embodiments herein is to configure a Multicast and Broadcast Services (MBS) specific data inactivity timer, wherein the data inactivity timer can track multicast and broadcast transmission from, or reception at, the one or more MAC entities associated with the UE.

Another object of the embodiments herein is to enable the UE to transit from the RRC_CONNECTED state to the RRC_INACTIVE state or the RRC_IDLE state on detecting that the MBS specific data inactivity timer has expired, and continue receiving the at least one of the multicast services and the broadcast services in the RRC_INACTIVE state or the RRC_IDLE state.

Another object of the embodiments herein is to receive, from a wireless network, a MBS configuration indicating whether the UE needs to operate in the RRC_CONNECTED state or whether the UE can operate in the RRC_INACTIVE state or the RRC_IDLE state.

Another object of the embodiments herein is to receive commands, from a wireless network, indicating the UE to transit to the RRC_CONNECTED state from the RRC_INACTIVE state or the RRC_IDLE state, or transit to the RRC_INACTIVE state or the RRC_IDLE state from the RRC_CONNECTED state.

Another object of the embodiments herein is to indicate, to the wireless network, whether the UE intends to receive the multicast services and the broadcast services, using a PTM bearer, a PTP bearer, or a combination of PTM and PTP bearers.

Another object of the embodiments herein is to enable the UE to transit to the RRC_CONNECTED state from the RRC_INACTIVE state or the RRC_IDLE state, if reliability required for communication between the UE and the wireless network is high, Quality of Service (QoS) is high, received signal strength is low, block error rate is high, if the multicast services and the broadcast services are being received through the PTP bearer, and so on.

Another object of the embodiments herein is to enable the UE to transit from the RRC_INACTIVE state or the RRC_IDLE state to the RRC_CONNECTED state or transit from the RRC_INACTIVE state or the RRC_IDLE state to RRC_CONNECTED state, and continue to receive the multicast services and the broadcast services, after expiry of a Timer Alignment (TA) timer.

Another object of the embodiments herein is to either maintain Hybrid Automatic Repeat Request (HARQ) buffers after the expiry of the TA timer, wherein HARQ feedback may be enabled in PTP bearer configuration or disabled in PTP bearer configuration and PTM bearer configuration; or flush the at least one HARQ buffer after the expiry of the TA timer in PTP bearer configuration and PTM bearer configuration.

Another object of the embodiments herein is to prevent the expiry of the TA timer by sending a Sounding Reference Signal (SRS), by the UE, to enable receiving TA commands from the wireless network; periodically transmitting a packet, a MAC Control Element (CE), and a padding Buffer Status Report (BSR), wherein the periodicity is shorter than a duration of the TA timer; activating MBS split bearer; and so on.

### Solution to Problem

Accordingly, the embodiments provide methods and systems for manage Radio Resource Control (RRC) state of a User Equipment (UE) and reception of Multicast and Broadcast Service (MBS) after expiry of a data inactivity timer. In an embodiment, the UE can detect at least one of a MBS transmission, a MBS reception, a unicast transmission, and a unicast reception, when the UE is in a RRC_CONNECTED state. In an embodiment, the MBS transmission comprises MBS multicast transmission, wherein Medium Access Control (MAC) Service Data Unit (SDU), pertaining to a Dedicated Traffic Channel (DTCH), is transmitted through a Point to Point (PTP) bearer. The MBS reception comprises MBS multicast reception, wherein MAC SDU pertaining to a MBS Traffic Channel (MTCH) is received through a Point to Multipoint (PTM) bearer, and/or MAC SDU pertaining to the DTCH is received through the the PTP bearer. The unicast transmission comprises transmitting MAC SDU pertaining to a DTCH and/or a Dedicated Control Channel (DCCH) for unicast services. The unicast reception comprises receiving MAC SDU pertaining to a DTCH, a DCCH, or a Common Control Channel (CCCH) for unicast services.

In an embodiment, the UE can detect expiry of a data inactivity timer or a MBS specific data inactivity timer. The data inactivity timer can be started or restarted, on determining at least one of the MBS transmission, the MBS reception, the unicast transmission, and the unicast reception. The MBS specific data inactivity timer can be started or restarted, on determining at least one of the MBS transmission and the MBS reception. The data inactivity timer can expire due to non-transmission and non-reception of the MBS multicast services, and non-transmission and non-reception of the unicast services, for a preconfigured time duration. The MBS specific data inactivity timer can expire due to non-transmission and non-reception of the MBS multicast services, for a preconfigured time duration.

The embodiments include informing at least one upper layer, such as RRC layer, an MBS service layer, a Packet Data Convergence Protocol (PDCP) layer, and a network layer, about the expiry of at least one of the data inactivity timer and the MBS specific data inactivity timer.

The embodiments include performing a transition from the RRC_CONNECTED state to one of a RRC_INACTIVE state and a RRC_IDLE state, on detecting expiry of the data inactivity timer, and/or the MBS specific data inactivity timer. Thereafter, the embodiments include autonomously releasing an existing RRC connection of the UE with a wireless network. In an embodiment, the UE can maintain PTM bearer configuration for at least one of the MBS multicast services and MBS broadcast services in the RRC_INACTIVE or the RRC_IDLE state during the MBS reception. The UE can either discard PTP bearer configuration for the MBS multicast services or store the PTP bearer configuration for MBS multicast services, in the RRC_INACTIVE state or the RRC_IDLE state during the MBS reception. In yet another embodiment, the UE can switch from a PTP bearer configuration to a PTM bearer configuration in the RRC_INACTIVE state or the RRC_IDLE state during the MBS reception.

In an embodiment, the MBS specific Data-Inactivity timer is one of stopped, and not operated, if a serving cell, serving the UE, is deactivated; a Bandwidth Part (BWP) of the serving cell is one of deactivated and dormant, and a Secondary Cell Group (SCG) associated with the UE is deactivated.

In an embodiment, the UE can receive a MBS configuration, from the wireless network, indicating whether the UE is allowed to switch to one of the RRC_INACTIVE state and the RRC_IDLE state, or the UE (101) needs to operate in the RRC_CONNECTED state. The MBS configuration can be provided in a RRC signalling message, a System Information Block (SIB), the MBS Control Channel (MCCH), and a MAC Control Element (CE). In an embodiment, the data inactivity timer is inoperable if the UE needs to operate in the RRC_CONNECTED state. The data inactivity timer is operable if the UE is allowed to switch to the RRC_INACTIVE state or the RRC_IDLE state.

In an embodiment, the UE can receive a command for RRC state transition from the wireless network during the MBS reception. The command may direct the UE to either transit to the RRC_CONNECTED state, from the RRC_INACTIVE state or the RRC_IDLE state, wherein the command is received either in a broadcast signalling message, a SIB, a MCCH, a paging message, a MAC CE, or a Physical Downlink Control Channel (PDCCH); or transit to either the RRC_INACTIVE state or the RRC_IDLE state, from the RRC_CONNECTED state, wherein the command is received either in a MAC CE, a RRC release message, a RRC reconfiguration message, a MBS Bearer Type Change (BTC) and a MBS state transition command.

In an embodiment, the UE can indicate, to the wireless network, whether the UE intends or prefers to perform the MBS transmission and the MBS reception either using PTM bearer configuration or PTP bearer configuration.

In an embodiment, the UE can remain in the RRC_CONNECTED state during the MBS transmission and the MBS reception.

The embodiments include managing Hybrid Automatic Repeat Request (HARQ) operation modes in the UE. If the UE detects that a Timing Alignment (TA) timer has expired, the UE can either maintain at least one HARQ buffer after the expiry of the TA timer, wherein HARQ feedback is disabled; or the UE can flush the at least one HARQ buffer after the expiry of the TA timer. The UE can perform MBS reception through at least one of the PTP bearer and the PTM bearer after expiry of the TA timer. In an embodiment, when HARQ feedback is supported on PTP before TA timer expiry, MBS reception is continued over PTP without HARQ feedback (or HARQ feedback is disabled) after TA timer expiry. In an embodiment, when HARQ feedback was not supported (or HARQ feedback is disabled) on PTP before TA timer expiry, MBS reception is continued over PTP after TA timer expiry. In an embodiment, the UE can perform the MBS reception through the PTM bearer after the expiry of the TA timer if the PTP bearer is not available after the expiry of the TA timer (or HARQ feedback cannot be supported for PTP). In an embodiment, the UE can prevent the expiry of the TA timer.

The embodiments include managing HARQ operation modes in the UE based on the RRC state of the UE. If the UE detects that the UE has transitioned from the RRC_CONNECTED state to the of RRC_IDLE state or RRC_INACTIVE state, the embodiments either maintain at least one HARQ buffer of at least one PTM bearer, wherein HARQ feedback is not enabled in the UE after transition to the of RRC_IDLE state or RRC_INACTIVE state; or disable HARQ operations and flush the at least one HARQ buffer of the at least one PTM bearer and the at least one PTP bearer.

If the UE detects that the UE has transitioned to the RRC_CONNECTED state from either the RRC_IDLE state or the RRC_INACTIVE state, the embodiments either maintain the at least one HARQ buffer of the at least one PTM bearer, wherein the HARQ feedback is not enabled in the UE after transition to the RRC_CONNECTED state; maintain the at least one HARQ buffer of the at least one PTM bearer, wherein the HARQ feedback is enabled in the UE after transition to the RRC_CONNECTED state; or disable HARQ operations and flush the at least one HARQ buffer of the at least one PTM bearer.

These and other aspects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to an embodiment of the disclosure, Radio Resource Control (RRC) state of a User Equipment (UE) during reception of unicast services, multicast services and broadcast services can be managed.

### BRIEF DESCRIPTION OF DRAWINGS

Embodiments herein are illustrated in the accompanying drawings, through out which like reference letters indicate corresponding parts in the various figures. The embodiments herein will be better understood from the following description with reference to the drawings, in which:

FIG. 1 depicts a system comprising a User Equipment (UE) and a wireless network, wherein the system is configured to manage Radio Resource Control (RRC) state of the UE and reception of Multicast and Broadcast Service (MBS) after expiry of a data inactivity timer, according to embodiments as disclosed herein;

FIG. 2 depicts example protocol stack architectures for UE implementation supporting reception of MBS multicast services and MBS broadcast services, according to embodiments as disclosed herein;

FIG. 3 is a flowchart depicting a method for managing RRC states of the UE using a configured Data-Inactivity timer based on transmission and/or reception of MBS and unicast, according to embodiments as disclosed herein;

FIG. 4 is a flowchart depicting a method for managing RRC states of the UE using a configured MBS-specific Data-Inactivity timer based on transmission and/or reception of MBS, and a configured Data-Inactivity timer based on transmission and/or reception of unicast, according to embodiments as disclosed herein;

FIG. 5A depicts an example switching between a Point to Multipoint (PTM) RLC bearer mode (reception path) and a Point to Point (PTP) RLC bearer mode (reception path) in a MBS split bearer configuration, according to embodiments as disclosed herein;

FIG. 5B depicts an arrangement for switching of MBS bearer configuration between Point to Multipoint (PTM) and Point to Point (PTP) bearers, wherein the switching is directed by network elements of the wireless network, according to embodiments as disclosed herein;

FIG. 6A depicts an example switching from a PTP RLC bearer mode (reception path) to a PTM RLC bearer mode (reception path) in a MBS split bearer configuration after the expiry of a Timing Alignment (TA) timer, according to embodiments as disclosed herein;

FIG. 6B depicts an example switching of MBS bearer configuration from a PTP bearer mode to a PTM bearer mode after the expiry of the TA timer, according to embodiments as disclosed herein; and

FIG. 7 is a flowchart depicting a method for managing Hybrid Automatic Repeat request (HARM) operations after the expiry of the TA timer, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

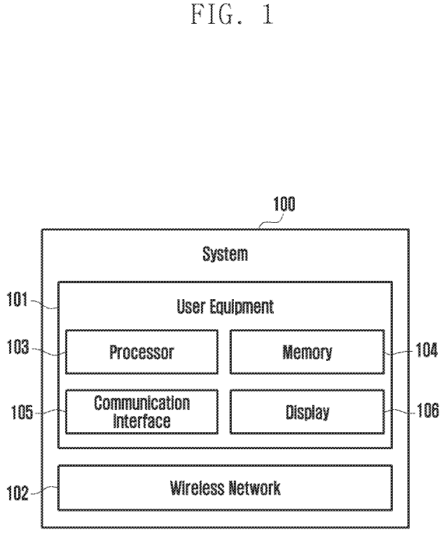

Embodiments herein disclose methods and systems for utilizing a data inactivity timer for tracking transmission and reception of unicast, and multicast services, and managing Radio Resource Control (RRC) state of a User Equipment (UE). Further, embodiments herein disclose methods and systems for utilizing a data inactivity timer and a Multicast and Broadcast Service (MBS) specific data inactivity timer for tracking transmission and reception of unicast, and multicast services, and managing RRC state of the UE. The embodiments include determining whether to mandate the UE to operate in the RRC_CONNECTED state or allow the UE to transit to the RRC_IDLE state or RRC_INACTIVE state when the UE is engaged in receiving multicast and broadcast services. Referring now to the drawings, and more particularly to FIGS. 1 through 7, where similar reference characters denote corresponding features consistently throughout the figures, there are shown preferred embodiments.

FIG. 1 depicts a system 100 comprising a UE 101 and a wireless network 102, wherein the system 100 is configured to manage RRC state of the UE 101 and reception of MBS after expiry of a Timer Alignment (TA) timer, according to embodiments as disclosed herein. As depicted in FIG. 1, the UE 101 comprises a processor 103, a memory 104, a communication interface 105, and a display 106. The wireless network can be a Long Term Evolution (LTE) network, a New Radio (NR) network, a 6th Generation (6G) network, and so on. In an embodiment, the UE 101 can receive MBS services through a PTM bearer, a PTP bearer or a combination of PTM and PTP bearers. A combination of PTM and PTP bearers can provide features that can lead to an increase in reliability of reception of MBS packets and efficient switching between PTM bearers and PTP bearers for the reception of the MBS packets. The switching may be necessitated because of mobility of the UE 101, loading conditions of the wireless network 102, user request density for the reception of the MBS, received signal strength at the UE 101, and so on. The wireless network 102 may determine whether MBS needs to be delivered to the UE 101 through the PTM bearer (by switching from the PTP bearer) or through the PTP bearer (by switching from the PTM bearer). In an embodiment, a bearer configuration having both PTM and PTP legs can be termed as MBS split bearer.

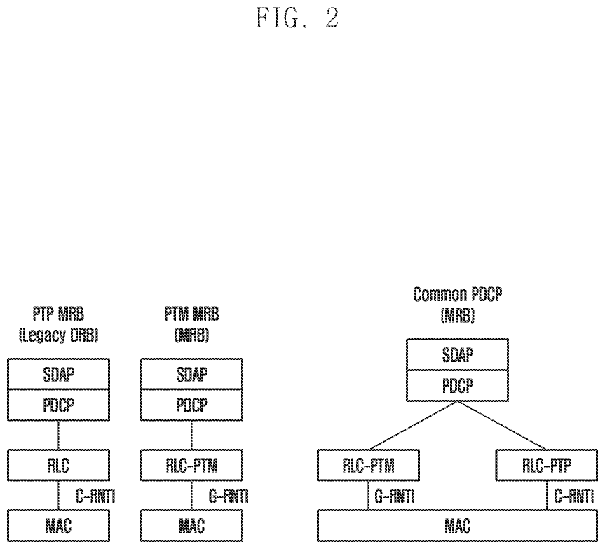

FIG. 2 depicts protocol stack architectures for UE 101 implementation supporting reception of the multicast services and the broadcast services, according to embodiments as disclosed herein. As depicted in FIG. 2, the protocol stack architectures can correspond to three types of radio bearer configurations comprising a PTP bearer based Radio Link Control (RLC) architecture (PTP MRB architecture), a PTM bearer based RLC architecture (PTM MRB architecture), and a combination of PTM bearer and PTP bearers based RLC architecture (MBS split bearer architecture). The

The PTM bearer based RLC architecture can operate in Unacknowledged Mode (UM), in which Automatic Repeat Request (ARQ) functionality is not supported. In UM, RLC level transmission is not supported as there is no feedback or status report exchanged between transmitting and receiving RLC entities. The PTP bearer based RLC architecture can operate in either UM or Acknowledged Mode (AM). In AM, the RLC layer can support status or feedback sharing from the receiving RLC entity to the transmitting RLC entity. In AM, the RLC layer can also support retransmission of NACKed RLC packets from the transmitting RLC entity to the receiving RLC entity. Therefore, AM facilitates enhancement in reliability of the communication between the transmitting and receiving RLC entities, which may allow achieving lossless operation.

The Packet Data Convergence Protocol (PDCP) layer performs packet reordering and employs a reordering timer “t-Reordering” to ensure that out-of-order packets, received from the PTM bearer based RLC layer, the PTP bearer based RLC layer, or the combination of the PTM bearer based RLC layer and the PTP bearer based RLC layer, can be re-arranged based on PDCP Sequence Numbers (SNs) associated with the out-of-order packets prior to the expiry of the reordering timer t-Reordering. When the reordering timer t-Reordering expires, there can be a gap in PDCP receiver window (due to a missing PDCP Protocol Data Unit (PDU) SN reordering and in-sequence delivery could not be completed at a higher layer). The PDCP can shift the receiver window by updating a state variable RX DELIV and ensure delivery of PDCP PDUs received until receiver window's lower edge.

In an MBS split bearer configuration, the combination of the PTM bearer based RLC layer and the PTP bearer based RLC layer increases the reliability in communication and allow achieving lossless operation using the PTP bearer, while the PTM bearer provides MBS packets with lower latency as no retransmission is involved, albeit with possible loss. Therefore, combining the two paths (PTP bearer and PTM bearer) through the PDCP reordering operation may increase the chances of receiving PDCP PDUs before the expiry of the t-Reordering timer and allow providing ordered in-sequence delivery to the higher layers.

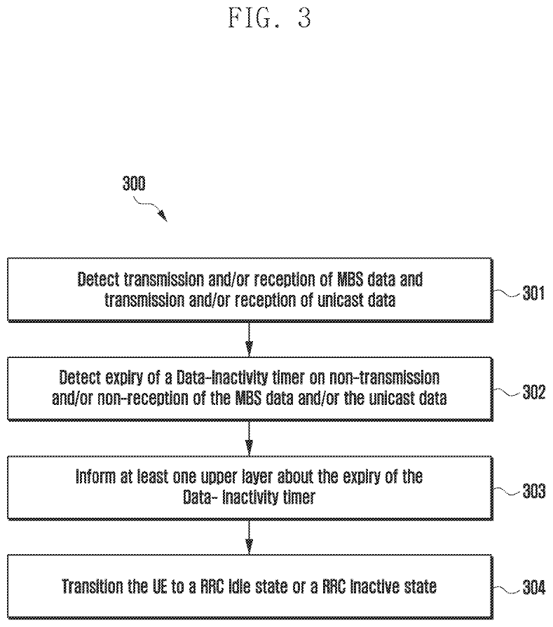

In an embodiment, the UE 101 can configure a Data-Inactivity timer. The Data Inactivity timer allows tracking reception of MBS Medium Access Control (MAC) Service Data Unit (SDU) pertaining to Multicast Traffic Channel (MTCH) logical channel corresponding to a PTM bearer and MBS MAC SDU pertaining to Dedicated Traffic Channel (DTCH) logical channel corresponding to a PTP bearer. The Data-Inactivity timer allows tracking transmission of MBS MAC SDU pertaining to the DTCH logical channel corresponding to a PTP bearer. The Data-Inactivity timer allows tracking transmission of unicast MAC SDU pertaining to Dedicated Control Channel (DCCH) logical channel and the DTCH logical channel. The Data-Inactivity timer allows tracking reception of unicast MAC SDU pertaining to the DTCH logical channel, the DCCH logical channel, and a Common Control Channel (CCCH). Effectively, Data-Inactivity timer performs a collective tracking for the afore-mentioned transmission and reception for the unicast and MBS multicast. FIG. 3 is a flowchart 300 depicting a method for managing RRC states of the UE 101 using the Data-Inactivity timer based on transmission and/or reception of MBS data and unicast data, according to embodiments as disclosed herein. At step 301, the method includes detecting transmission and/or reception of MBS and transmission and/or reception of unicast. If any MAC entity associated with the UE 101 receives or transmits a MBS MAC SDU and/or unicast MAC SDU, the UE 101 can start or restart (if Data-Inactivity timer has been started and is running) the Data-Inactivity timer. The Data-Inactivity timer tracks reception of MBS MAC SDU pertaining to MTCH logical channel and MBS MAC SDU pertaining to DTCH logical channel. The Data-Inactivity timer tracks transmission of MBS MAC SDU pertaining to DTCH logical channel. The Data-Inactivity timer tracks transmission of unicast MAC SDU pertaining to DCCH logical channel and unicast MAC SDU pertaining to DTCH logical channel. The Data-Inactivity timer tracks reception of unicast MAC SDU pertaining to DCCH logical channel, unicast MAC SDU pertaining to DTCH logical channel, and unicast MAC SDU pertaining to CCCH logical channel.

At step 302, the method includes detecting expiry of the Data-Inactivity timer. The Data-Inactivity timer can expire if there is non-transmission of MBS and unicast, and non-reception of MBS and unicast, for a preconfigured time period. At step 303, the method includes informing at least one upper layer about the expiry of the Data-Inactivity timer. When the Data-Inactivity timer expires, the processor 103 can indicate the same to an upper layer such as RRC layer, PDCP layer, MBS service layer, and so on. If the RRC layer receives the indication about the expiry of the Data-Inactivity timer, the RRC connection can be locally released (at the UE 101). At step 304, the method includes transitioning the UE 101 to the RRC_IDLE state or the RRC_INACTIVE state. The UE 101 can transit to the RRC_IDLE state or the RRC_INACTIVE state after the RRC connection is locally released. In scenarios wherein the UE 101 receives MBS only through the PTM bearer, the RRC layer can maintain PTM bearer configuration and continue to receive MBS in the RRC_IDLE state or the RRC_INACTIVE state. In scenarios wherein the UE 101 receives MBS only through the PTM and PTP bearers, the RRC layer can either maintain PTM bearer configuration or switches to the PTM bearer (i.e. PTP to PTM), and continue to receive MBS in the RRC_IDLE state or the RRC_INACTIVE state. Alternatively, the UE 101 may store PTP configuration for potential switching back to the PTP bearer after reverting to the RRC_CONNECTED state.

In an embodiment, the UE 101 may be configured, by the RRC layer, with a data inactivity monitoring functionality, when the UE 101 is in the RRC_CONNECTED state. The RRC layer can control data inactivity operation by configuring a dataInactivityTimer (Data-Inactivity timer).

When dataInactivityTimer is configured, the UE 101 shall:
1. If any MAC entity receives a MAC SDU for DTCH logical channel (for PTP MBS or unicast), DCCH logical channel, CCCH logical channel, or MTCH for multicast MBS; or
1. If any MAC entity transmits a MAC SDU for DTCH logical channel (for PTP MBS or unicast), or DCCH logical channel:
2. Start or restart dataInactivityTimer.
1. If the dataInactivityTimer expires:
2. Indicate the expiry of the dataInactivityTimer to upper layers.

In an embodiment, it is specified in the standards or configured by the network entity (gNB) to the UE through RRC signaling (e.g. RRC reconfiguration message), whether the UE is transitioned to RRC_IDLE or transitioned to RRC_INACTIVE. Further, this may be dependent on the kind of MBS services are being operated at the UE e.g. low latency multicast services, UE may be transitioned to RRC_INACTIVE state, otherwise, UE may be transitioned to RRC_IDLE state.

In an embodiment, the UE may not operate the Data-Inactivity timer, while the UE 101 is receiving MBS, in a plurality of conditions comprising: unicast services are not configured in the UE 101, unicast services are not active in the UE 101, the UE 101 is receiving broadcast services only, the UE 101 is receiving MBS in PTM bearer mode, and MBS service can be received/continued in RRC_IDLE state/RRC_INACTIVE state (either by continuing in PTM bearer mode or by switching from MBS split bearer mode or PTP bearer mode to PTM bearer mode). Alternatively, the processor 103 may not start, or stop, the Data-Inactivity timer.

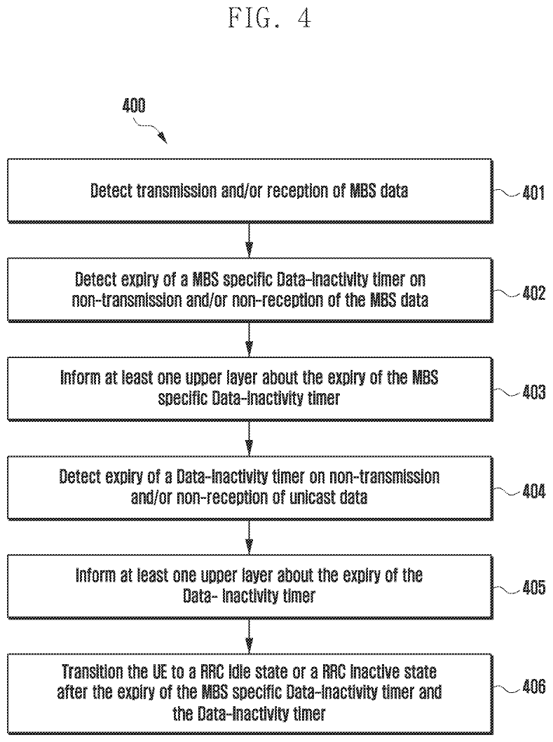

In an embodiment, the processor 103 can configure a MBS-specific Data-Inactivity timer. FIG. 4 is a flowchart 400 depicting a method for managing RRC states of the UE 101 using the MBS-specific Data-Inactivity timer based on transmission and/or reception of MBS, according to embodiments as disclosed herein. At step 401, the method includes detecting transmission/reception of MBS. The MBS-specific Data-Inactivity timer is configured for tracking reception of MAC SDU through PTM bearer, and/or tracking transmission/reception of MAC SDU through PTP bearer. The MBS can be availed on the same Bandwidth Part (BWP) as unicast or on dedicated BWP(s). In an embodiment, the UE 101 can operate the MBS specific Data-Inactivity timer in isolation from the Data-Inactivity timer, which is used for tracking unicast transmission or unicast reception, if configured in the UE 101.

At step 402, the method includes detecting expiry of the MBS specific Data-Inactivity timer. The MBS specific Data-Inactivity timer can expire if there is non-transmission of MBS, and non-reception of MBS, for a preconfigured time period. At step 403, the method includes informing at least one upper layer about the expiry of the MBS specific Data-Inactivity timer. When the MBS specific Data-Inactivity timer expires, the processor 103 can indicate the same to an upper layer such as RRC layer, PDCP layer, MBS layer, and so on. At step 404, the method includes detecting that the Data-Inactivity timer has expired. The Data-Inactivity timer can expire if there is non-transmission of unicast, and non-reception of unicast, for the preconfigured time period. At step 405, the method includes informing the at least one upper layer about the expiry of the Data-Inactivity timer. When the Data-Inactivity timer expires, the processor 103 can indicate the same to an upper layer such as RRC layer, PDCP layer, MBS service layer, and so on. In an embodiment, the upper layers can check, on determining that the MBS specific Data-Inactivity timer has expired, whether the Data-Inactivity timer, tracking unicast transmission/reception, has expired. On determining the expiry of the MBS specific Data-Inactivity timer and the Data-Inactivity timer, the method includes, at step 406, transitioning the UE 101 to a RRC_IDLE state or the RRC_INACTIVE state. The upper layers such as RRC layer can locally (at the UE 101) release the RRC connection and allow the UE 101 to transition to the RRC_IDLE state or the RRC_INACTIVE state. If the processor 103 determines that both timers, i.e., the MBS specific Data-Inactivity timer and the Data-Inactivity timer, have expired, the RRC layer can release the RRC connection and allow the UE 101 to transition to the RRC_IDLE state or the RRC_INACTIVE state.

Similarly, when the upper layer (RRC layer) determines that the Data-inactivity timer has expired, the processor 103 can check whether the MBS specific Data-Inactivity timer has expired. If both timers (MBS specific Data-Inactivity timer and Data-Inactivity timer) have expired, the RRC layer can release the RRC connection and allow the UE 101 to transit to the RRC_IDLE state or the RRC_INACTIVE state.

In an embodiment, the UE 101 may be configured, by the RRC layer, with a data inactivity monitoring functionality for MBS transmission and reception, when the UE 101 is in the RRC_CONNECTED state. The RRC layer can control MBS data inactivity operation by configuring an MBSdataInactivityTimer.

When MBSdataInactivityTimer is configured, the UE 101 shall:
1. If any MAC entity receives a MAC SDU for DTCH logical channel (for PTP MBS) or MTCH logical channel multicast MBS; or
1. If any MAC entity transmits a MAC SDU for DTCH logical channel (for PTP MBS):
2. Start or restart MBSdataInactivityTimer.
1. If the MBSdataInactivityTimer expires:
2. Indicate the expiry of the MBSdataInactivityTimer to upper layers.

Upon receiving the expiry of MBSdataInactivityTimer from lower layers while in RRC_CONNECTED, the UE 101 shall:
1. Perform the actions upon going to the RRC_IDLE or RRC_INACTIVE with release cause ‘RRC connection failure’.

In an embodiment, the UE 101 may be configured, by the RRC layer, with a data inactivity monitoring functionality for unicast and MBS, when the UE 101 is in the RRC_CONNECTED state. The RRC layer can control MBS data inactivity operation by configuring an MBSdataInactivityTimer. The RRC layer can control unicast data inactivity operation by configuring a dataInactivityTimer (Data-Inactivity timer).

When MBSdataInactivityTimer is configured, the UE 101 shall:
1. If any MAC entity receives a MAC SDU for DTCH logical channel (for PTP MBS) or MTCH logical channel for multicast MBS; or
1. If any MAC entity transmits a MAC SDU for DTCH logical channel (for PTP MBS):
2. Start or restart MBSdataInactivityTimer.
1. If the MBSdataInactivityTimer expires:
2. Indicate the expiry of the MBSdataInactivityTimer to upper layers.

When dataInactivityTimer is configured, the UE 101 shall:
1. If any MAC entity receives a MAC SDU for a DTCH logical channel (for unicast), DCCH logical channel, or CCCH logical channel; or
1. If any MAC entity transmits a MAC SDU for DTCH logical channel (for unicast), or DCCH logical channel:
2. Start or restart dataInactivityTimer.
1. If the dataInactivityTimer expires:
2. Indicate the expiry of the dataInactivityTimer to upper layers.

Upon receiving the expiry of dataInactivityTimer and MBSdataInactivityTimer from lower layers while in RRC_CONNECTED, the UE 101 shall:
1. Perform the actions upon going to RRC_IDLE or RRC_INACTIVE with release cause ‘RRC connection failure’.

In an embodiment, if MBS split bearer is (re-)configured at RRC release, the UE 101 may release only the PTP logical channel and corresponding RLC entity. In an embodiment, MBS specific Data Inactivity timer can be operated only for PTM logical channels (MTCH). This is described as follows:

In an embodiment, the wireless network 102 can provide a MBS configuration to the UE 101 that can include a “KeepConnectedMode” field. The value of the KeepConnectedMode field can either ensure that the UE 101 remains in the RRC_CONNECTED state for MBS reception or allow the UE 101 to transit to the RRC_IDLE state or the RRC_INACTIVE state during MBS reception.

In an embodiment, if KeepConnectedMode=1, then the UE 101 remains in the RRC_CONNECTED state. In an embodiment, if KeepConnectedMode=0, then the UE 101 is allowed to transit to the RRC_IDLE state or the RRC_INACTIVE state.

In an embodiment, the KeepConnectedMode field can be configured for the UE 101, for one or more MBS multicast services received by the UE 101, and/or one or more logical channels belonging to the MBS received by the UE 101. In an embodiment, the MBS configuration can be provided along with RRC signaling messaged such as RRC reconfiguration. In another embodiment, the MBS configuration can be provided by in broadcasted configuration through System Information Block (SIB), MCCH in the RRC_IDLE state, the RRC_INACTIVE state, or the RRC_CONNECTED state, MAC Control Element (CE).

In an embodiment, the “KeepConnectedMode” field in the MBS configuration can be a single bit information specific to the UE 101 and/or specific to the MBS received by the UE 101. Further, the MBS specific Data-Inactivity timer and/or the Data-Inactivity timer may not be operated or stopped when the KeepConnectedMode field for one or more MBS is set to 1 (UE 101 needs to remain in the RRC_CONNECTED state. The MBS configuration, comprising the “KeepConnectedMode” field, allows the wireless network 102 to configure the UE 101 for customized handling of RRC states of the UE 101 while receiving specific types of MBS services in specific conditions such as certain multicast services are allowed to be received by the UE 101 in the RRC_IDLE state or the RRC_INACTIVE state, certain broadcast services to be allowed to be received by the UE 101 in the RRC_CONNECTED state, the configuration or indication to the UE 101 is dynamically changed based on performance criteria such as throughput, error rate, latency, and so on, service reliability requirement, existing signal conditions, and so on.

In an embodiment, the wireless network 102 can explicitly send a command to the UE 101 to transit to the RRC_IDLE state or the RRC_INACTIVE state while receiving MBS. For example, the wireless network 102 can send the command when MBS is not available at the wireless network 102 and when the wireless network 102 prefers that the UE 101 remains in the RRC_IDLE state or the RRC_INACTIVE state to reduce power consumption of the UE 101. In an embodiment, the wireless network 102 can determine that the UE 101 needs to receive MBS through PTM bearer based RLC entity. The wireless network 102 can switch bearer configuration for MBS reception from MBS split bearer or PTP bearer to PTM bearer and/or indicate the UE 101 to transit to the RRC_IDLE state or the RRC_INACTIVE state, by sending the command.

In an embodiment, the wireless network 102 can send the command to the UE 101 using a RRC release message, a RRC reconfiguration, a MAC CE, a MBS Bearer Type Change (BTC) or a MBS state transition command. In another embodiment, the wireless network 102 can direct the UE 101 to transition to the RRC_CONNECTED state through broadcast signaling, System Information Block (SIB), MBS Control Channel (MCCH), notification, paging, or MBS embedded signaling such as Physical Downlink Control Channel (PDCCH), MAC CE, and so on, to transit to the RRC_CONNECTED state. Further, the wireless network 102 can discontinue providing MBS or allow the UE 101 to continue to receive MBS in the RRC_CONNECTED state when MBS availability/scheduling are not present.

In an embodiment, MBS can be configured, by the wireless network 102, with a field “KeepConnectedMode” field to either direct the UE 101 to be in the RRC_CONNECTED state for MBS reception or to allow the UE 101 to transit to the RRC_IDLE state or the RRC_INACTIVE state for MBS reception, when either of the dataInactivityTimer or the MB SdataInactivityTimer expires.

In an embodiment, if the wireless network 102 has configured MBS with KeepConnectedMode=0 for the UE 101 and all MBS service types, the MBS specific Data Inactivity timer and/or the Data-Inactivity timer can be operated to consider reception of MAC SDU pertaining to MTCH logical channels corresponding to PTM bearer, and transmission/reception of MAC SDU pertaining to DTCH logical channels corresponding to PTP path. If any MAC entity associated with the UE 101 transmits or receives a MAC SDU, the Data-Inactivity timer can be started or restarted (if the Data-Inactivity timer has been started and is running). When the MBS specific Data-Inactivity timer and/or the Data-Inactivity timer expires, the upper layers such as RRC, PDCP, MBS service layer, and so on, can be informed about the expiry. For instance, when the RRC layer determines that the MBS specific Data-Inactivity timer and/or the Data-Inactivity timer has expired, the UE 101 locally releases the RRC connection and enables the UE 101 to transit to the RRC_IDLE state or the RRC_INACTIVE state.

In an embodiment, the UE 101 may be configured, by the RRC layer, with a data inactivity monitoring functionality for MBS reception, when the UE 101 is in the RRC_CONNECTED state. The RRC layer can control MBS data inactivity operation by configuring an MBSdataInactivityTimer. Further, the wireless network 102 can configure the KeepConnectedMode field specifically for the UE 101 and/or all MBS received by the UE 101, and one or more logical channels belonging to the MBS.

If the wireless network 102 has configured the KeepConnectedMode=0 for the UE 101, and/or all MBS received by the UE 101, and if the MBSdataInactivityTimer is configured, the UE 101 shall:
1. If any MAC entity receives a MAC SDU for DTCH logical channel (for PTP MBS) or MTCH logical channel multicast MBS; or
1. If any MAC entity transmits a MAC SDU for DTCH logical channel (for PTP MBS):
2. Start or restart MBSdataInactivityTimer.
1. If the MBSdataInactivityTimer expires:
2. Indicate the expiry of the MBSdataInactivityTimer to upper layers.

Upon receiving the expiry of MBSdataInactivityTimer from lower layers while in RRC_CONNECTED, the UE 101 shall:
1. Perform the actions upon going to RRC_IDLE or RRC_INACTIVE with release cause ‘RRC connection failure’.

In an embodiment, the data inactivity timer is started by selected MTCH/MCCH. For instance, if the UE 101 receives MBS packets through particular MBS Logical Channels (LCHs), then the Data Inactivity timer or the MBS specific Data Inactivity timer can be (re)started. If the UE 101 receives MBS packets from other MBS LCHs, the Data Inactivity timer or the MBS specific Data Inactivity timer may not be (re)started. The RRC configuration, specific to each logical channel (or MBS radio bearer), can configure whether to start/restart the Data Inactivity timer or the MBS specific Data Inactivity timer.

In an embodiment, the UE 101 determines whether to remain in the RRC_CONNECTED state, while receiving MBS, based on service configuration. For instance, when there is a need for high reliability (as indicated by service type such as multicast), higher Quality of service (QoS) requirement, higher Quality of Experience (QoE) requirement, lower packet delay budget, lower block/packet error rate, Hybrid Automatic Repeat Request (HARQ) retransmission and/or feedback requirement, and so on, the UE 101 may decide to stay in the RRC_CONNECTED state. In an embodiment, the UE 101 may decide to stay in the RRC_CONNECTED state if MBS is received through PTP bearer or MBS split bearer.

In an embodiment, the UE 101 may decide to stay in the RRC_CONNECTED state based on the signal strength conditions such as Reference Signal Received Power (RSRP), Reference Signal Received Quality (RSRQ), Reference Signal Strength Indicator (RSSI), Signal and Interference to Noise Ratio (SINR), and Channel Quality Indicator (CQI), as estimated based on link measurements and adaptation. Further, the UE 101 may consider thresholds for each signal strength conditions, which are configured by the wireless network 102. When the UE 101 detects that the one or more thresholds are not met, the UE 101 determines to continue in the RRC_CONNECTED state. In such a scenario, the UE 101 does not operate the MBS specific Data-Inactivity timer or the Data-Inactivity timer (if the timers have been configured and/or running).

In an embodiment, the UE 101 may indicate, to the wireless network 102, its preference to receive MBS through PTP bearer or PTM bearer. The UE 101 may send the indication to the wireless network 102 either through a MBS Interest Indication message, a counting response message, a UE assistance information message, a unicast uplink message, a RRC signaling message, a MAC CE, L−1 signaling message such as Uplink Control Information (UCI), and so on.

In an embodiment, the MBS specific Data-Inactivity timer may be stopped or not operated when a single serving cell or all serving cells are deactivated; or Bandwidth Part (BWP) of the serving cell, on which the UE 101 is receiving the MBS, is either deactivated or dormant. In an embodiment, the Data-Inactivity timer may be stopped or not operated when a single serving cell or all serving cells are deactivated; or BWP of the serving cell, on which the UE 101 is receiving the MBS and/or unicast, is either deactivated or dormant. In an embodiment, for unicast service reception, when one serving cell or serving cells are deactivated, or the BWP of the serving cell is either deactivated or dormant, the Data-Inactivity timer may be stopped or not operated.

In an embodiment, for unicast reception, the Data-Inactivity timer may not be started or restarted when the MAC SDU pertaining to Common Control Channel (CCCH) logical channel is received. In another embodiment, the CCCH logical channel may not be considered for operating the Data-Inactivity timer.

In an embodiment, when Secondary Cell Group (SCG) is deactivated (all Secondary cells (SCells) including the Primary Secondary cell (PSCell) are deactivated), the Data-Inactivity timer is stopped. The Data-Inactivity timer is kept stopped from the time instant when SCG is released/deactivated/removed/de-configured to the time instant when SCG (or at least the PSCell) is configured and/or activated again.

Timing Alignment (TA) Timer Operation:

There can be issues pertaining to TA timer handling while operating MBS in the RRC_CONNECTED state. The issues can be compounded when there is no unicast service configured or unicast service is not active, and when the UE 101 is engaged in receiving MBS though PTM bearer. In these scenarios, the UE 101 may not be transmitting any uplink data packet. Therefore, without any uplink transmission from the UE 101, the wireless network 102 may not be able to provide TA command to the UE 101 and the TA timer run at the UE 101 will expire. In certain MBS configurations and wireless networks, Sounding Reference Signal (SRS) is not configured and/or is not used for timing alignment purpose. Further, if the UE 101 is receiving the MBS using MBS split bearer, the wireless network 102 needs to ensure that either the PTM bearer or the PTP bearer, or both the PTM and PTP bearers are active.

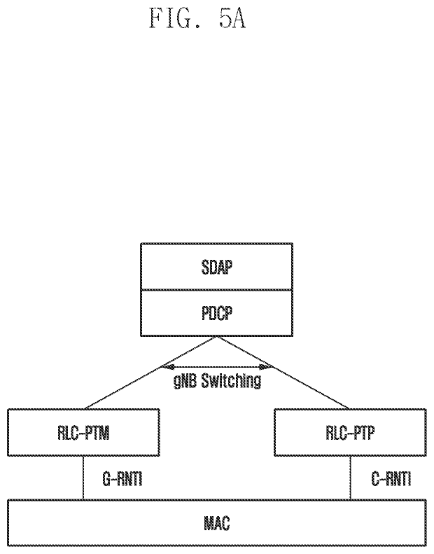

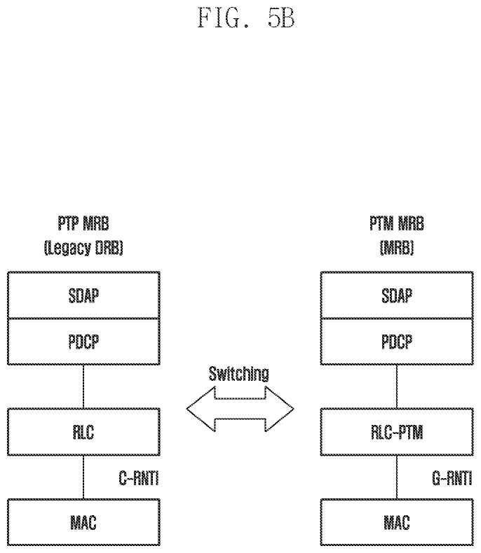

FIG. 5A depicts an arrangement for switching between PTP and PTM RLC bearers (PTM or PTP reception path) in a MBS split bearer configuration. The switching can be facilitated by network elements (such as gNB) based on network configuration. The switching may not be visible to the UE 101. Alternatively, the wireless network 102 may utilize explicit signaling to perform the switching. FIG. 5B depicts an arrangement for switching from PTP bearer to PTM bearer, and switching from PTM bearer to PTP bearer. In an embodiment, the wireless network 102 may utilize explicit signaling to perform the switching

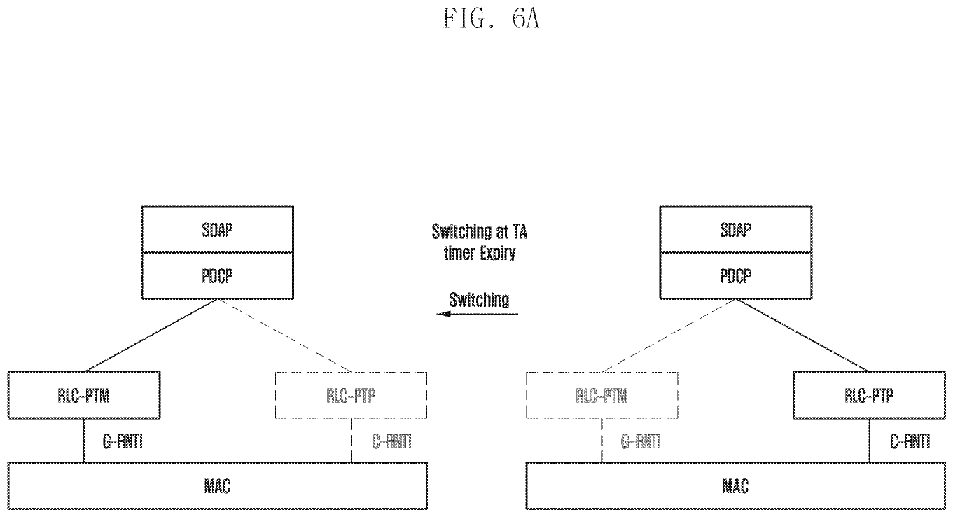

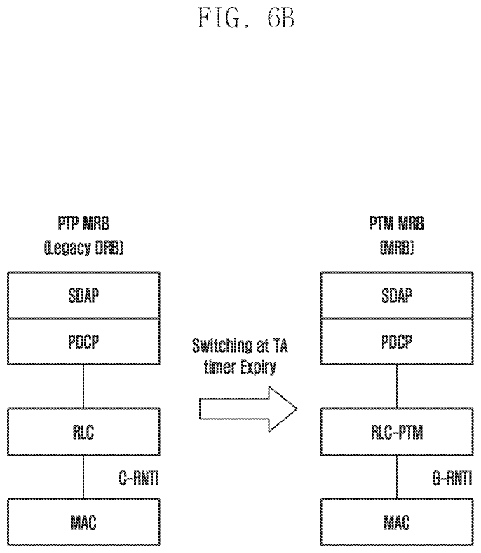

FIG. 6A depicts an arrangement for switching from PTP RLC bearer to PTM RLC bearer (PTP reception path to PTM reception path) in a MBS split bearer configuration after the expiry of the TA timer. The switching may not be visible to the UE 101. Alternatively, the wireless network 102 may utilize explicit signaling to perform the switching FIG. 6B depicts an arrangement for switching from PTP bearer to PTM bearer, after the expiry of the TA timer. In an embodiment, the wireless network 102 may utilize explicit signaling to perform the switching.

In an embodiment, in order to prevent the TA timer from expiring, the wireless network 102 may configure and utilize SRS signaling. The wireless network 102 may frequently send TA commands to the UE 101, and the UE 101 can be configured to send SRS signals to the wireless network 102 for timing alignment.

In an embodiment, the wireless network 102 may enable the PTP path on the MBS split bearer to ensure uplink transmission from the UE 101 within TA timer duration. In another embodiment, the UE 101 can periodically transmit or retransmit a packet, a MAC CE, or a padding Buffer Status Report (BSR), to the wireless network 102, wherein the periodicity is smaller than the TA timer duration. In order to ensure the periodic transmission or retransmission from the UE 101, a timer may be configured at the UE 101, wherein the timer can expire prior to the expiry of the TA timer and the UE 101 is configured to transmit or retransmit the packet, the MAC CE, or the padding Buffer Status Report (BSR) prior to the expiry of the timer.

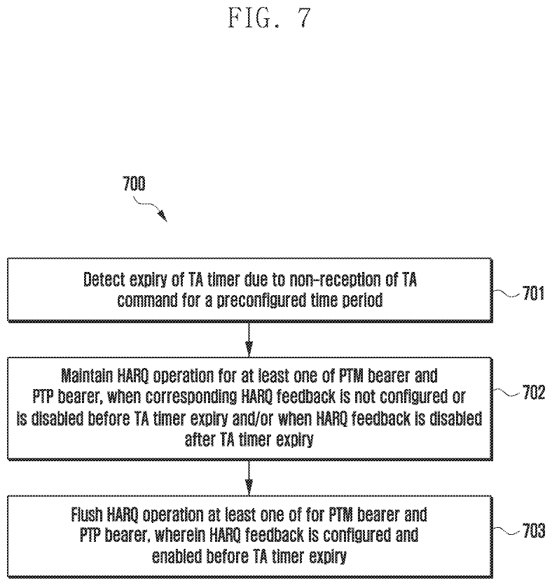

FIG. 7 is a flowchart 700 depicting a method for managing Hybrid Automatic Repeat request (HARQ) operations after the expiry of the TA timer, according to embodiments as disclosed herein. At step 701, the method includes detecting expiry of TA timer due to non-reception of TA command for a preconfigured time period. At step 702, the method includes maintaining HARQ operation for at least one of PTM bearer and PTP bearer, when corresponding HARQ feedback is not configured or is disabled before TA timer expiry and/or when HARQ feedback is disabled after TA timer expiry.

In an embodiment, the UE 101 can continue to receive MBS using PTM bearers or PTP bearers after TA timer expiry. The embodiments may enable or disable HARQ operations after the expiry of the TA timer. In an embodiment, if HARQ operations are enabled, HARQ feedback is not configured. In an embodiment, if HARQ operations are enabled and HARQ feedback is configured, then HARQ feedback is disabled. In an embodiment, the UE 101 may exclude HARQ buffers of at least one of the PTM bearers and the PTP bearers from flushing when the TA timer expires. The UE 101 may continue MBS reception using at least one of PTM bearers and PTP bearers, after TA timer expiry without HARQ feedback.

At step 703, the method includes flushing HARQ operation at least one of for PTM bearer and PTP bearer, wherein HARQ feedback is configured and enabled before TA timer expiry. In an embodiment, the UE 101 can flush the HARQ buffers of at least one of the PTM bearers and the PTP bearers when the TA timer expires.

In an embodiment, if the HARQ retransmission for the PTM initial transmission is through PTP retransmission before TA timer expiry, then after TA timer expiry it is performed or reconfigured or expected that HARQ retransmission for the PTM initial transmission is through PTM retransmission and further, HARQ feedback is disabled or not configured or not provided by the UE 101.

In an embodiment, if the UE 101 transits to the RRC_IDLE state/RRC_INACTIVE state after TA timer expiry, the UE 101 can continue to receive MBS through PTM bearers. If the MBS split bearer is configured, then at RRC release, the UE 101 may release one or more logical channels corresponding to PTP bearers.

HARQ changes during RRC state transition:

In an embodiment, when the UE 101 transits from the RRC_CONNECTED state to the RRC_IDLE state or the RRC_INACTIVE state, HARQ operations can be enabled or disabled. If HARQ operation is disabled, HARQ buffers of the PTM bearer can be cleared (flushed). The UE 101 receives MBS through the PTM bearers without HARQ support. If HARQ operation is enabled, the HARQ buffers of the PTM bearer are maintained, but HARQ feedback is disabled. The UE 101 can receive MBS through the PTM bearers without HARQ feedback. The UE 101 can receive HARQ transmissions and retransmissions. The UE 101 does not send Acknowledgement (ACK) packets or Negative ACK (NACK) packets to the wireless network 102. The HARQ retransmissions can be received by the UE 101 in response to HARQ NACK being sent by other UEs (101) (the other UEs (101) are in the RRC_CONNECTED state and are receiving the same MBS as the UE 101). Therefore, PTM bearers in the RRC_IDLE state or RRC_INACTIVE state can check for HARQ retransmissions when there is a decoding error at the UE for a first transmission. The UE 101 can soft combine the first HARQ transmission and HARQ retransmissions to recover data.

In an embodiment, when the UE 101 transits from the RRC_CONNECTED state to the RRC_IDLE state or the RRC_INACTIVE state, HARQ buffers of the PTP bearer can be cleared or flushed. The UE 101 may not operate the PTP bearer.

In an embodiment, when the UE 101 transits to the RRC_CONNECTED state, from the RRC_IDLE state or the RRC_INACTIVE state, HARQ operations can be carried out for the PTM bearers and the PTP bearers in the following modes:
a) HARQ operation is enabled, HARQ feedback is disabled, and HARQ buffers are initialized.
b) HARQ operation is enabled, HARQ feedback is enabled, and HARQ buffers are initialized.
c) HARQ operation is continued, and HARQ buffers are maintained.
d) HARQ operation is not applied (disabled).

When there is switching between PTP bearer and PTM bearer, i.e. PTP→PTM or PTM→PTP, the HARQ operation mode can be changed for the new bearer mode. After expiry of the TA timer, the UE 101 can switch from the PTP bearer to the PTM bearer for MBS reception, and perform HARQ operation in a particular mode. After transition from the RRC_CONNECTED state to one of the RRC_IDLE state or the RRC_INACTIVE state, HARQ operation mode can be switched from either of HARQ supported mode to HARQ supported with no feedback mode, HARQ supported mode to No HARQ supported mode, No HARQ supported mode to HARQ supported mode, No HARQ supported mode to HARQ supported with no feedback mode, HARQ supported with no feedback mode to HARQ supported mode, and HARQ supported with no feedback mode to No HARQ supported mode. (It is to be noted that “HARQ supported mode” includes HARQ supported with feedback mode, if not stated otherwise).

In an embodiment, when there is a transition from the RRC_CONNECTED state to the RRC_IDLE state or the RRC_INACTIVE state, or transition to the RRC_CONNECTED state from the RRC_IDLE state or the RRC_INACTIVE state; or when there is switching from PTP bearer to PTM bearer, or from PTM bearer to PTP bearer; and HARQ operation mode is changed from HARQ supported mode to HARQ supported with no feedback mode, HARQ supported mode to No HARQ supported mode, HARQ supported with no feedback mode to No HARQ supported mode, or HARQ supported with no feedback mode to HARQ supported mode; the UE 101 may not configure, or disable, the PDCP reordering timer. When HARQ operation is changed from No HARQ supported mode to HARQ supported mode or No HARQ supported mode to HARQ supported with no feedback mode, the UE 101 may configure, or enable the PDCP reordering timer.

In an embodiment, the HARQ profile used for the HARQ operation in PTP bearer mode and PTM bearer mode can be different, i.e., maximum number of retransmissions supported for HARQ can be different in PTP and PTM bearer modes. In an embodiment, explicit HARQ configuration signaling can be utilized to change the HARQ operation mode, HARQ parameters, and HARQ profile and so on. In another embodiment, implicit or dynamic change of the HARQ configuration can be performed based on MBS service characteristics and other conditions such as signal conditions, packet error rate, reliability requirements, and so on.

FIG. 1 shows exemplary units of the system 100, but it is to be understood that other embodiments are not limited thereon. In other embodiments, the system 100 may include less or more number of units. Further, the labels or names of the units of the system 100 are used only for illustrative purpose and does not limit the scope of the invention. One or more units can be combined together to perform same or substantially similar function in the system 100.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiments disclosed herein describe methods and systems for managing RRC state of a UE during reception of unicast services, multicast services and broadcast services; configuring a data inactivity timer for tracking multicast and unicast transmission, enabling the UE to transit from a RRC_CONNECTED state to a RRC_INACTIVE state or RRC_IDLE state on detecting that the data inactivity timer has expired; and enabling receiving the multicast services and the broadcast services after the expiry of the TA timer. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in example Very high speed integrated circuit Hardware Description Language (VHDL), or any other programming language, or implemented by one or more VHDL or several software modules being executed on at least one hardware device. The hardware device can be any kind of portable device that can be programmed. The device may also include means, which could be, for example, a hardware means, for example, an Application-specific Integrated Circuit (ASIC), or a combination of hardware and software means, for example, an ASIC and a Field Programmable Gate Array (FPGA), or at least one microprocessor and at least one memory with software modules located therein. The method embodiments described herein could be implemented partly in hardware and partly in software. Alternatively, the invention may be implemented on different hardware devices, e.g. using a plurality of Central Processing Units (CPUs).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for managing Radio Resource Control (RRC) state in a User Equipment (UE) (101), the method comprising:
detecting, by the UE (101), at least one of a Multicast and Broadcast Service (MBS) transmission from at least one Medium Access Control (MAC) entity associated with the UE (101) or a MBS reception at the at least one MAC entity associated with the UE (101), wherein the UE (101) is operating in a RRC_CONNECTED state;
detecting, by the UE (101), expiry of a data inactivity timer, wherein the data inactivity timer is one of started and restarted, on determining at least one of the MBS transmission or the MBS reception; and
performing, by the UE (101), a transition from the RRC_CONNECTED state to one of a RRC_INACTIVE state and a RRC_IDLE state, on detecting expiry of the data inactivity timer.

2. The method of claim 1, wherein the expiry of a data inactivity timer is indicated to at least one of a RRC layer, an MBS service layer, a Packet Data Convergence Protocol (PDCP) layer, or a network layer; and
wherein the transition of the RRC state to one of the RRC_INACTIVE state and the RRC_IDLE state involves the UE (101) autonomously releasing an existing RRC connection with a wireless network (102).

3. The method of claim 1,
wherein the data inactivity timer expires on non-transmission of the MBS, non-reception of the MBS, non-transmission of unicast, and non-reception of unicast, for a preconfigured time period,
wherein the non-transmission of the MBS comprises non-transmission of MBS multicast transmission and the non-reception of the MBS comprises non-reception of MBS multicast reception,
wherein the MBS multicast transmission comprises transmitting MAC Service Data Unit (SDU) pertaining to a Dedicated Traffic Channel (DTCH) corresponding to a Point to Point (PTP) bearer,
wherein the MBS multicast reception comprises receiving MAC SDU pertaining to at least one of: a MBS Traffic Channel (MTCH) corresponding to a Point to Multipoint (PTM) bearer or a DTCH corresponding to the PTP bearer,
wherein the unicast transmission comprises transmitting MAC SDU pertaining to at least one of: a DTCH or a Dedicated Control Channel (DCCH) for unicast services, and
wherein the unicast reception comprises receiving MAC SDU pertaining to at least one of: a DTCH, a DCCH or a Common Control Channel (CCCH) for unicast services.

4. The method of claim 1,
wherein the UE (101) indicates to the wireless network at least one of:
a preference to perform the MBS transmission and MBS reception using a PTP bearer, a preference to perform the MBS reception using a PTM bearer, or a preference to perform the MBS transmission and the MBS reception using the a MBS split bearer,
wherein the preference is included in an MBS Interest Indication message, a MBS Counting Response message, a UE assistance information message, an unicast uplink message, a RRC signalling message, a MAC Control Element (CE), or a L−1 signalling message comprising an Uplink Control Information (UCI).

5. The method of claim 3, wherein, the method further comprises at least one of:
maintaining PTM bearer configuration for at least one of MBS multicast or MBS broadcast in one of the RRC_INACTIVE and the RRC_IDLE state during the MBS reception;
maintaining the PTM bearer configuration for at least one of MBS multicast and MBS broadcast and performing one of discarding PTP bearer configuration for MBS multicast and storing the PTP bearer configuration for MBS multicast, in one of the RRC_INACTIVE state and the RRC_IDLE state during the MBS reception; and
switching from a PTP bearer configuration to a PTM bearer configuration in one of the RRC_INACTIVE state and the RRC_IDLE state during MBS reception.

6. The method of claim 1, further comprising:
detecting, by the UE (101), expiry of a MBS specific data inactivity timer, wherein the MBS specific data inactivity timer is one of started and restarted, on determining at least one of the MBS transmission or the MBS reception;
detecting, by the UE (101), expiry of the data inactivity timer, wherein the data inactivity timer is one of started or restarted, on determining the at least one of unicast transmission or unicast reception; and
performing, by the UE (101), a transition of the RRC state from the RRC_CONNECTED state to one of the RRC_INACTIVE state and the RRC_IDLE state,
wherein the MBS specific Data-Inactivity timer is one of stopped and not operated, in at least one condition comprising: a serving cell, serving the UE (101), is deactivated, a Bandwidth Part (BWP) of the serving cell is one of deactivated and dormant, or a Secondary Cell Group (SCG) associated with the UE (101) is deactivated.

7. The method of claim 1, further comprising:
receiving, by the UE (101), a MBS configuration from the wireless network, wherein the MBS configuration indicates whether the UE (101) is allowed to switch to one of the RRC_INACTIVE state and the RRC_IDLE state, or the UE (101) needs to operate in the RRC_CONNECTED state,
wherein the MBS configuration is provided in one of a RRC signalling message, a System Information Block (SIB), the MBS Control Channel (MCCH), and a MAC CE, and
wherein the data inactivity timer is inoperable if the UE (101) needs to operate in the RRC_CONNECTED state; and wherein the data inactivity timer is operable if the UE (101) is allowed to switch to one of the RRC_INACTIVE state and the RRC_IDLE state.

8. The method of claim 1, further comprising:
detecting, by the UE (101), that the UE (101) has transitioned from the RRC_CONNECTED state to one of the RRC_IDLE state and the RRC_INACTIVE state; and
performing, by the UE (101), at least one of:
maintaining at least one Hybrid Automatic Repeat Request (HARQ) buffer of at least one Point to Multipoint (PTM) bearer, wherein HARQ feedback is not enabled in the UE (101) after transition) to one of the RRC_IDLE state and the RRC_INACTIVE state; or
disabling the HARQ operations and flushing the at least one HARQ buffer of the at least one PTM bearer or at least one HARQ buffer of at least one Point to Point (PTP) bearer.

9. The method of claim 1, further comprising: detecting, by the UE (101), expiry of a Timing Alignment (TA) timer;
performing, by the UE (101), an action comprising at least one of:
maintaining at least one HARQ buffer after the expiry of the TA timer, wherein HARQ feedback is disabled; or
flushing the at least one HARQ buffer after the expiry of the TA timer; and
performing the MBS reception after expiry of the TA timer, wherein the MBS reception is performed through at least one of the PTP bearer or a Point to Multipoint (PTM) bearer.

10. A method for managing Radio Resource Control (RRC) state in a User Equipment (UE) (101), the method comprising:
receiving, by the UE (101), a command for RRC state transition from a wireless network (102) during Multicast and Broadcast Services (MBS) reception, wherein the command directs the UE (101) to one of:
transit to a RRC_CONNECTED state, from one of a RRC_INACTIVE state and a RRC_IDLE state, wherein the command is received in one of a broadcast signalling message, a SIB, a paging message, a Medium Access Control (MAC) Control Element (CE), a MCCH and a Physical Downlink Control Channel (PDCCH); and
transit to one of the RRC_INACTIVE state and the RRC_IDLE state, from the RRC_CONNECTED state, wherein the command is received in one of a MAC CE, a RRC release message, a RRC reconfiguration message, a MBS Bearer Type Change (BTC) and a MBS state transition command.

11. The method of claim 10, wherein the MBS reception is enabled through a MTCH corresponding to a PTM bearer if the command directs the UE (101) to remain in one of the RRC_INACTIVE state and the RRC_IDLE state, and wherein the MBS reception active on a DTCH corresponding to the PTP bearer is switched to the MTCH corresponding to the PTM bearer.

12. The method of claim 10, further comprising:
detecting, by the UE (101), that the UE (101) has transitioned to the RRC_CONNECTED state from one of the RRC_IDLE state and the RRC_INACTIVE state; and
performing, by the UE (101), at least one of:
maintaining the at least one HARQ buffer of the at least one PTM bearer, wherein the HARQ feedback is not enabled in the UE (101) after transition to the RRC_CONNECTED state;
maintaining the at least one HARQ buffer of the at least one PTM bearer, wherein the HARQ feedback is enabled in the UE (101) after transition to the RRC_CONNECTED state;
enabling HARQ operations for the at least one PTM bearer and the at least one PTP bearer; or
disabling HARQ operations and flushing the at least one HARQ buffer of the at least one PTM bearer.

13. A method for managing Radio Resource Control (RRC) state in a User Equipment (UE) (101), the method comprising enabling the UE (101) to remain in a RRC_CONNECTED state in at least one condition pertaining to Multicast and Broadcast Service (MBS) transmission and MBS reception at the UE (101), the at least one condition comprising: requirement of reliability for communication between the UE (101) and a wireless network (102) is greater than a preconfigured reliability threshold, Quality of Service (QoS) requirement for MBS transmission and MBS reception is greater than a preconfigured QoS threshold, Quality of Experience (QoE) requirement for MBS transmission and MBS reception is greater than a preconfigured QoE threshold, packet delay budget requirement is lower than a preconfigured threshold time period, block error rate requirement is lower than a preconfigured tolerable error rate, requirement of Hybrid Automatic Repeat Request (HARQ) retransmission and HARQ feedback, requirement of MBS transmission and reception through a Point to Point (PTP) bearer, a received Reference Signal Received Power (RSRP) is lower than a preconfigured threshold RSRP, a received Reference Signal Received Quality (RSRQ) is lower than a preconfigured threshold RSRQ, a received Reference Signal Strength Indicator (RSSI) is lower than a preconfigured threshold RSSI, a received Signal and Interference to Noise Ratio (SINR) is lower than a preconfigured threshold SINR, or a measured Channel Quality Indicator (CQI) is lower than a preconfigured threshold CQI.

14. A User Equipment (UE) (101) for managing Radio Resource Control (RRC) state, the UE (101) configured to:
detect at least one of a Multicast and Broadcast Service (MBS) transmission from at least one Medium Access Control (MAC) entity associated with the UE (101) or a MBS reception at the at least one MAC entity associated with the UE (101), wherein the UE (101) is operating in a RRC_CONNECTED state;
detect expiry of a data inactivity timer, wherein the data inactivity timer is one of started and restarted, on determining at least one of the MBS transmission or the MBS reception; and
perform a transition from the RRC_CONNECTED state to one of a RRC_INACTIVE state and a RRC_IDLE state, on detecting expiry of the data inactivity timer.

15. the UE (101) of claim 14, the UE (101) configured to:
detect that the UE (101) has transitioned from the RRC_CONNECTED state to one of the RRC_IDLE state and the RRC_INACTIVE state; and
perform at least one of:
maintain at least one Hybrid Automatic Repeat Request (HARQ) buffer of at least one Point to Multipoint (PTM) bearer, wherein HARQ feedback is not enabled in the UE (101) after transition) to one of the RRC_IDLE state and the RRC_INACTIVE state; or
disable the HARQ operations and flushing the at least one HARQ buffer of the at least one PTM bearer or at least one HARQ buffer of at least one Point to Point (PTP) bearer.
